(19) United States
(12) Patent Application Publication
(10) Pub. No.: US 2026/0023181 A1
(43) Pub. Date: Jan. 22, 2026

(54) RANGING APPARATUS

(71) Applicant: CANON KABUSHIKI KAISHA, Tokyo (JP)

(72) Inventor: KAZUYUKI SHIGETA, Tokyo (JP)

(21) Appl. No.: 18/668,444

(22) Filed: May 20, 2024

(30) Foreign Application Priority Data
May 24, 2023 (JP) 2023-085401

(51) Int. Cl. G01S 17/18; G01S 17/894

(52) U.S. Cl. CPC G01S 17/18; G01S 17/894

(57) ABSTRACT

A ranging apparatus includes a light source portion which emits light, a setting portion which performs light emission setting of the light source portion, a light receiving portion which receives reflected light of the light emitted from the light source portion and reflected by an object, and a generating portion which generates a distance image using the reflected light received by the light receiving portion. The distance image is made up of a plurality of sub-frames of distance images, in a process of generating the plurality of sub-frames, the setting portion performs first light emission setting when performing ranging of a first distance range and performs second light emission setting when performing ranging of a second distance range, and the first light emission setting and the second light emission setting include setting of an irradiated region of the light emitted by the light source portion.

### BACKGROUND

### Field

The techniques according to the present disclosure relate to a ranging apparatus.

### Description of the Related Art

Conventionally, apparatuses which irradiate a ranging object region with modulated light and receive reflected light from a ranging object and which repeat exposure for each distance segment in a depth direction of the ranging object region to acquire a plurality of pieces of distance information in the depth direction are proposed.

Japanese Translation of PCT Application No. 2021-513087 proposes varying the number of cycles of irradiated light in accordance with a distance segment in a depth direction of a ranging object region. Accordingly, an effect of improving quality of an obtained distance image can be expected in spite of the fact that the greater the distance to a ranging object region, the weaker the reflected light from a ranging object.

However, increasing the number of cycles of irradiated light creates a problem of increasing power consumption by a light source.

### SUMMARY

The techniques according to the present disclosure have been devised in consideration of the problem described above and an object thereof is to improve accuracy of distance information of a ranging object while suppressing an increase in power consumption of a light source in a ranging apparatus.

According to some embodiments, a ranging apparatus includes a light source portion which emits light, a setting portion which performs light emission setting of the light source portion, a light receiving portion which receives reflected light of the light having been emitted from the light source portion and reflected by an object, and a generating portion which generates a distance image using the reflected light having been received by the light receiving portion, wherein the distance image is made up of a plurality of sub-frames of distance images, in a process of generating the plurality of sub-frames, the setting portion performs first light emission setting when performing ranging of a first distance range and performs second light emission setting when performing ranging of a second distance range, and the first light emission setting and the second light emission setting include setting of an irradiated region of the light emitted by the light source portion.

Further features of the present invention will become apparent from the following description of exemplary embodiments with reference to the attached drawings.

### BRIEF DESCRIPTION OF THE DRAWINGS

FIG. 1 is a schematic view for describing ranging by a ranging apparatus according to an embodiment;

FIG. 2 is a diagram showing a schematic configuration of the ranging apparatus according to the embodiment;

FIGS. 3A to 3C are graphs schematically showing timing control of light emission and light reception of the ranging apparatus;

FIG. 4 is a diagram schematically showing a method of acquiring distance information of a ranging object with the ranging apparatus;

FIG. 5 is a graph that enlarges a part of a variation in each of the signals shown in FIGS. 3A to 3C;

FIG. 6 is a schematic view showing an example of processing of acquiring distance information in the ranging apparatus;

FIG. 7 is a diagram schematically showing distance information acquired with a sub-frame shown in FIG. 6 as an object;

FIG. 8 is a graph showing a relationship among a modulation signal, a gate signal, and a setting signal in the ranging apparatus;

FIG. 9 is a schematic view showing an example of a case where the ranging apparatus is applied as a vehicle-mounted ranging apparatus;

FIGS. 10A and 10B are diagrams schematically showing an imaging region due to the ranging apparatus;

FIGS. 11A to 11D are graphs showing a relationship among various signals in a modification;

FIG. 12 is a diagram showing a schematic configuration of a ranging apparatus according to a third embodiment;

FIG. 13 is a diagram showing a schematic configuration of a ranging apparatus according to a fourth embodiment;

FIG. 14 is a diagram showing a schematic configuration of a ranging apparatus according to a fifth embodiment;

FIG. 15 is a schematic view showing a part of a configuration, light emission, and light reception of a ranging apparatus according to a sixth embodiment;

FIGS. 16A and 16B are graphs showing a relationship between a modulation signal and a gate signal in a seventh embodiment;

FIGS. 17A and 17B are diagrams schematically showing light emission and light reception of a ranging apparatus according to an eighth embodiment; and

FIG. 18 is a diagram showing an example of a configuration of a light receiving portion of a ranging apparatus according to a ninth embodiment.

### DESCRIPTION OF THE EMBODIMENTS

Hereinafter, embodiments of the present invention will be described in detail with reference to the drawings. It should be noted that constituent elements of each embodiment described below may be added to another embodiment or replaced with constituent elements of another embodiment. It should also be noted that sizes, positional relationships, and the likes of members shown in each of the drawings may sometimes be exaggerated for the sake of better understanding.

### First Embodiment

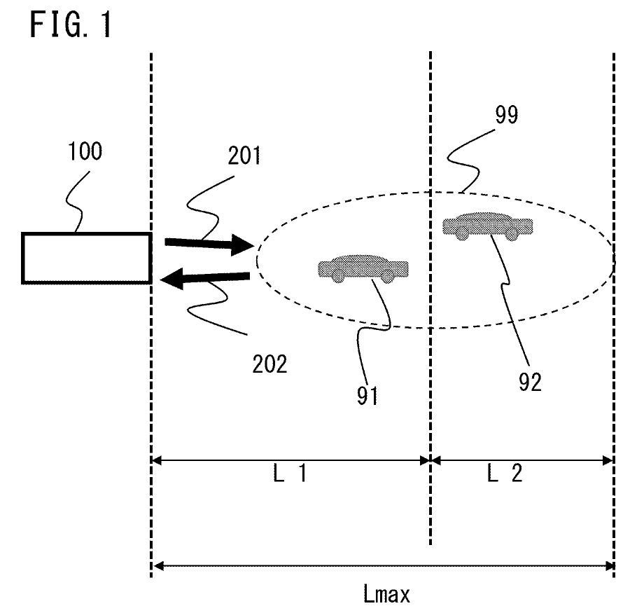

Hereinafter, a ranging apparatus according to a first embodiment will be described with reference to FIG. 1 to FIGS. 10A and 10B. In the embodiments described below, elements with the same function may be denoted by same reference characters and a description thereof may be either omitted or simplified.

FIG. 1 is a diagram showing ranging by a ranging apparatus according to the first embodiment. As shown in FIG. 1, a ranging apparatus 100 irradiates ranging objects 91 and 92 as objects in a ranging object region 99 with irradiation light 201 and receives reflected light 202 which is reflected by the ranging objects 91 and 92. In addition, the ranging apparatus 100 performs ranging of the ranging objects 91 and 92 using the received reflected light 202 and generates a distance image using a ranging result.

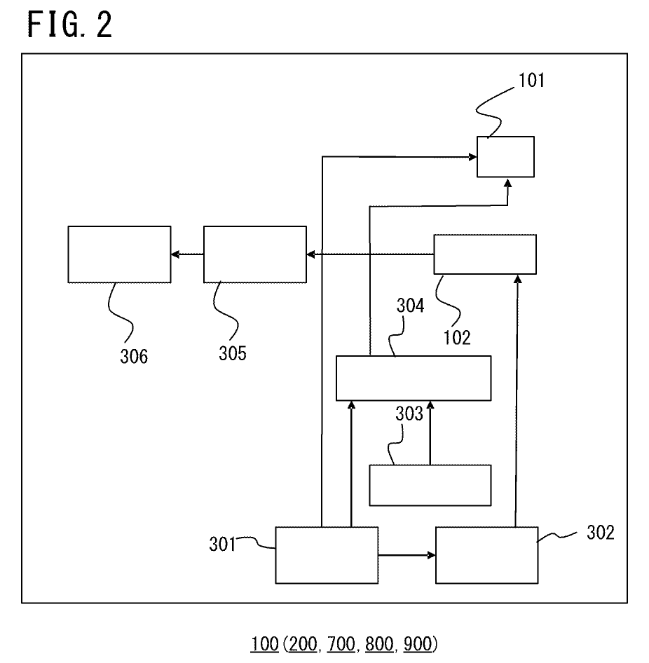

FIG. 2 is a diagram showing a schematic configuration of the ranging apparatus 100 according to the present embodiment. As shown in FIG. 2, the ranging apparatus 100 includes a light source portion 101 which emits the irradiation light to a ranging object and a light receiving portion 102 which receives the reflected light from the ranging object. In addition, the ranging apparatus 100 includes a timing control portion 301, a gate signal generating portion 302, a storage portion 303, a setting portion 304, a frame image generating portion 305, and an image synthesizing portion 306.

The timing control portion 301 transmits to the gate signal generating portion 302, a control signal for controlling generation of a gate signal by the gate signal generating portion 302. In addition, the timing control portion 301 transmits a control signal for controlling a modulation timing of the light source portion 101 to the light source portion 101 and transmits a timing signal for switching among irradiated regions of light to the setting portion 304. The gate signal generating portion 302 generates a control signal (gate signal) of a light reception timing of the light receiving portion 102 and transmits the control signal (gate signal) to the light receiving portion 102.

The storage portion 303 stores information related to a first light emission setting of the light source portion 101 to be used for ranging of a first ranging range among a ranging region and information related to a second light emission setting of the light source portion 101 to be used for ranging of a second ranging range among the ranging region. According to the timing signal transmitted from the timing control portion 301, the setting portion 304 acquires the information related to the first light emission setting or the information related to the second light emission setting from the storage portion 303 and transmits a setting signal based on the acquired information to the light source portion 101. The light source portion 101 switches between light emission settings based on the setting signal received from the setting portion 304. Accordingly, the ranging apparatus 100 can modify an irradiation range of light by the light source portion 101.

The reflected light received by the light receiving portion 102 is converted into a signal and image information for each distance segment is generated in sub-frame units by the frame image generating portion 305. In addition, the image synthesizing portion 306 synthesizes sub-frame images for each distance segment having been generated by the frame image generating portion 305 and generates a distance image.

In the present embodiment, the light source portion 101 has a function of modifying a distance range to be irradiated with light and emits light according to a control signal for controlling a modulation timing which is received from the timing control portion 301. In addition, the light source portion 101 switches light emission settings between the first light emission setting and the second light emission setting according to the setting signal received from the setting portion 304.

The ranging apparatus 100 irradiates the ranging object region 99 with a predetermined depth with the irradiation light 201 from the light source portion 101 and receives the reflected light 202 having been reflected by the ranging objects 91 and 92 in the ranging object region 99 with the light receiving portion 102. Accordingly, the ranging apparatus 100 acquires distance information in the depth direction of the ranging object region 99.

The light source portion 101 emits light in a prescribed time period and irradiates the ranging object region 99 with uniform irradiation light. Any light source can be adopted as the light source portion 101 as long as the light source is capable of modulating the light source itself at high speed as in the case of an LED (Light Emitting Diode) and the light source portion 101 may not only modulate the light source itself but may also include a component outside the light source for controlling the irradiation light with a chopper or the like.

Furthermore, examples of the component included in the light source portion 101 for modifying the distance range to be irradiated with light include those which use polarization or modulation such as a silicon photonics device, a compound semiconductor, and an optical phased array. Alternatively, examples of the component included in the light source portion 101 for modifying the distance range to be irradiated with light include those which switch among light emission areas with a surface-emitting laser made up of a plurality of laser point groups. Alternatively, the light source portion 101 may be a light source unit which includes a plurality of laser light-emitting diode groups and may modify the distance range to be irradiated with light by, for example, switching among laser diode groups that emit light according to a control signal from the timing control portion 301.

In addition, although not illustrated in FIG. 2, the light source portion 101 may include an optical element such as a diffractive optical element (DOE) or a glass diffuser plate in order to irradiate the ranging object region 99 with a uniform light amount of light.

The light receiving portion 102 is constituted of one or more light receiving elements. The light receiving element has a function of assuming a light-receivable state (Ron) only during a prescribed period. In addition, the light receiving element is configured to detect only a light amount received in the period where the light receiving element is in the light-receivable state. Accordingly, information related to light reception by the light receiving portion 102 can be readily extracted and apparatus configuration can be simplified as compared to a case of adopting a configuration of constantly monitoring the reflected light 202. Furthermore, since the light receiving portion 102 is no longer required to perform high-speed constant sampling, power consumption in the ranging apparatus 100 can be reduced and a distance image with higher accuracy can be generated with a simple system configuration.

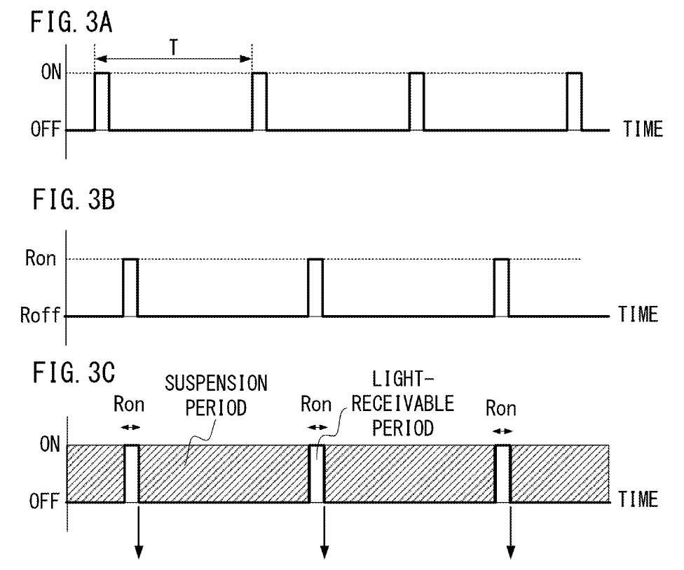

FIGS. 3A to 3C are graphs schematically showing timing control of light emission and light reception in the ranging apparatus 100 according to the present embodiment. In the graphs shown in FIGS. 3A to 3C, an abscissa represents time and an ordinate represents a signal level. The graph shown in FIG. 3A represents a modulation signal which is a control signal of a modulation timing of the light source portion 101 and the light source portion 101 emits light during a period where the light source portion 101 is in an ON state but does not emit light during a period where the light source portion 101 is in an OFF state. In this case, the period where the light source portion 101 is in the ON state is periodically repeated at constant time intervals T. In addition, the time intervals T are set so as to be longer than a maximum delay time Tmax until the irradiation light 201 is reflected at a deepest position (in FIG. 1, a position at a distance of Lmax from the ranging apparatus 100) in the depth direction of the ranging object region 99 and returns to the light receiving portion 102.

The graph shown in FIG. 3B shows a control signal which changes the light receiving element of the light receiving portion 102 described above to the light-receivable state (Ron). In this case, the control signal shown in FIG. 3B which is generated by the gate signal generating portion 302 will be referred to as a gate signal. The light receiving element of the light receiving portion 102 assumes the light-receivable state (Ron) only during the period where the gate signal is ON. In addition, as shown in FIGS. 3A and 3B, the ON state of the control signal which controls light emission of the light source portion 101 and the ON state of the gate signal which controls light reception of the light receiving portion 102 are repeated so as to form pairs.

FIG. 3C shows an operation timing of the light receiving portion 102 which operates according to the gate signal shown in FIG. 3B. The light receiving element of the light receiving portion 102 assumes a light-receivable state only during a period where the gate signal is turned ON and detects an amount of light irradiated during the period where the gate signal is turned ON, and the light receiving portion 102 outputs a detection signal in accordance with the detected light amount as a detection result. As the light receiving element of the light receiving portion 102, any element can be adopted as long as the element can assume a light-receiving state only during the light-receivable period according to the gate signal and can output an exposure amount during the light reception period as a detection signal.

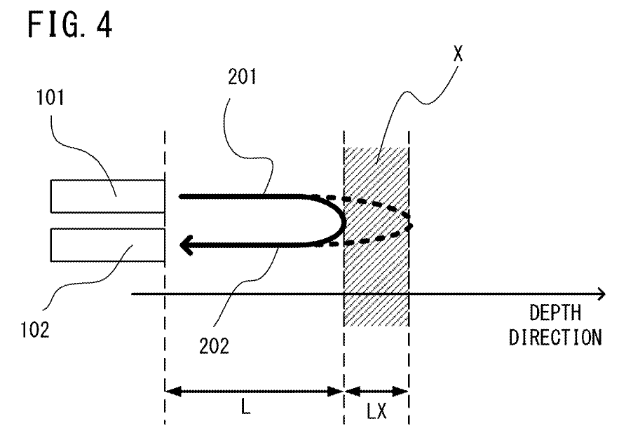

A method of acquiring distance information of a ranging object in the ranging apparatus 100 will now be described with reference to FIG. 4. As shown in the drawing, distance information in the depth direction of the ranging object region 99 is acquired by irradiating the ranging object region 99 with a prescribed depth with the irradiation light 201 from the light source portion 101 and receiving the reflected light 202 from a ranging object by the light receiving portion 102. Specifically, the ranging object region 99 is divided into a plurality of distance ranges in the depth direction and the ranging apparatus 100 repetitively acquires the distance information by performing irradiation of light by the light source portion 101 and reception of reflected light by the light receiving portion 102 for each divided distance range. In addition, the ranging apparatus 100 acquires distance information of the plurality of distance ranges in the depth direction of the ranging object region 99.

In FIG. 4, an operation will be described in which the light source portion 101 acquires distance information of a distance range X created by distance division in the depth direction when the light source portion 101 emits light once in order to acquire the distance information corresponding to one distance range. The time it takes from the light source portion 101 emitting the irradiation light 201 until the light returns to the light receiving portion 102 after being reflected by a ranging object in the divided distance range X can be calculated from a distance L to the distance range X, a distance LX of the depth direction of the distance range X, and the speed of light c. The gate signal generating portion 302 generates a gate signal and transmits the gate signal to the light receiving portion 102 so that the light receiving portion 102 assumes a light-receivable state only during a period where the reflected light 202 from the ranging object in the distance range X reaches the light receiving portion 102.

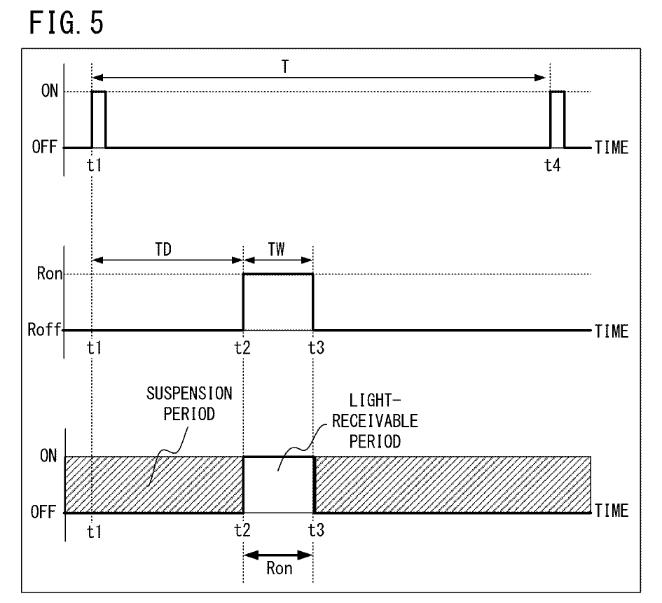

A gate signal that places the light receiving element in a light-receivable state (Ron) will be described with reference to FIG. 5. FIG. 5 is a graph that enlarges a part of a variation in each of the signals shown in FIGS. 3A to 3C. As described above, ON/OFF states of the modulation signal that controls a modulation timing of the light source portion 101 and ON/OFF states of the gate signal that controls light reception of the light receiving portion 102 constitute pairs. As shown in FIG. 5, a delay time between the modulation signal that controls a modulation timing of the light source portion 101 changing to the ON state (time t1) and the gate signal changing to the ON state (time t2) is denoted by TD. In addition, a time width during which the gate signal is turned ON is denoted by TW. In this case, a time between the light source portion 101 emitting light toward a ranging object in the distance range X and an earliest ray of reflected light 202 among the rays of reflected light 202 reflected by the ranging object reaching the light receiving portion 102 corresponds to the delay time TD. In addition, the earliest ray of reflected light 202 from the distance range X or, in other words, a ray of reflected light 202 which returns from a nearest ranging object to the ranging apparatus 100 (light receiving portion 102) reaches the light receiving portion 102. Furthermore, a last ray of reflected light 202 or, in other words, a ray of reflected light 202 which returns from the farthest ranging object to the ranging apparatus 100 (light receiving portion 102) reaches the light receiving portion 102. A time interval from the earliest ray of reflected light 202 reaching the light receiving portion 102 to the last ray of reflected light 202 reaching the light receiving portion 102 is the time width TW.

In addition, FIG. 5 also shows a graph representing an example of a period during which the light receiving element of the light receiving portion 102 assumes the light-receivable state shown in FIG. 3C. As shown in the graph, from the emission of light by the light source portion 101 (time t1) to the passage of the delay time TD (time t2), the light receiving element of the light receiving portion 102 is in a state where the reflected light 202 is not received. Once the delay time TD elapses from the time t1, the light receiving element of the light receiving portion 102 changes to a state where the reflected light 202 becomes receivable. The light-receivable state of the light receiving element continues for a period corresponding to the time width TW after the light receiving element assumes the light-receivable state. Once the time width TW elapses after the light receiving element assumes the light-receivable state, the light receiving element returns to a non-light-receiving state. When the light receiving element returns to the non-light-receiving state (time t3), the light receiving element outputs a detection signal in accordance with the light amount received during the light-receivable state as a detection result. The light receiving portion 102 outputs the detected signal once so as to correspond to the light source portion 101 emitting light once between the time t1 and the time t4.

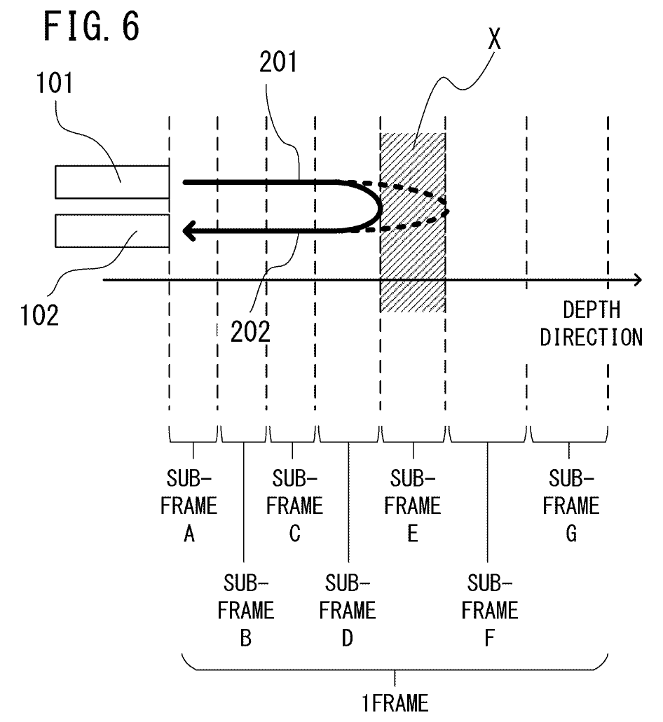

FIG. 6 is a schematic view describing processing of acquiring distance information from a plurality of distance ranges in the ranging apparatus 100. In the present embodiment, by controlling the ON/OFF states of the light-receivable state of the light receiving element using gate signals, the ranging apparatus 100 acquires pieces of distance information respectively corresponding to distance ranges divided in the depth direction of the ranging object region 99. In the following description, distance information obtained with one distance range among the distance ranges divided in the depth direction of the ranging object region 99 as an object will be referred to as a sub-frame.

Furthermore, the ranging apparatus 100 can acquire a plurality of pieces of distance information from the ranging object region 99 by controlling the operation of the light receiving portion 102 with a gate signal in accordance with each distance range and acquiring the distance information of each sub-frame. For example, when the number of divisions of distance ranges in the depth direction of the ranging object region 99 is Y, Y-number of pieces of distance information are considered one distance information group. The example shown in FIG. 6 corresponds to a case where Y = 7 in which the ranging object region 99 is divided into seven sub-frames from a sub-frame A to a sub-frame G in a descending order of proximity from the ranging apparatus 100 and the seven sub-frames constitute one frame. In the drawing, the sub-frame E corresponds to the distance range X described above.

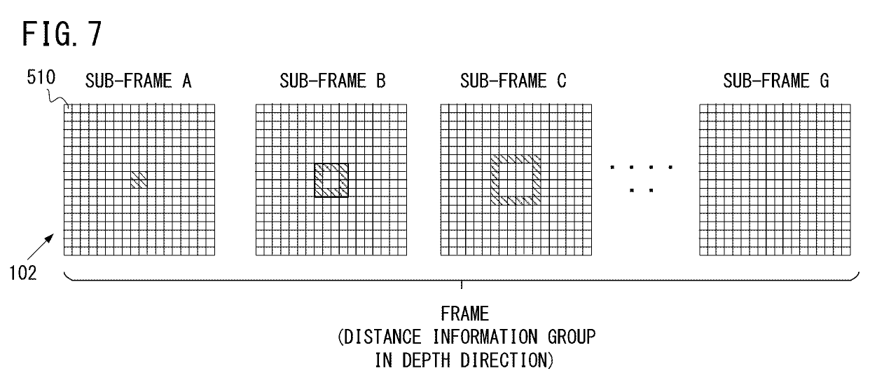

Next, FIG. 7 schematically shows distance information acquired with a sub-frame shown in FIG. 6 as an object. In the example shown in FIG. 7, it is assumed that the light receiving portion 102 is constituted of a plurality of light receiving elements 510 in an array pattern. A distance information group of all of the sub-frames in the depth direction of the ranging object region 99 constitutes one frame and a time it takes to acquire one frame’s worth of distance information in the ranging apparatus 100 is referred to as a frame rate. The frame rate in this case can be calculated by "(interval T of modulation timing of light source portion 101 (period from time t1 to time t4 in FIG. 5)) × (number of divisions Y of ranging object region in depth direction)".

While distance information corresponding to an amount of received light is acquired for each of the seven sub-frames A to G created by dividing the ranging object region 99 in the depth direction in the example shown in FIG. 6, a method of acquiring distance information is not limited thereto. For example, distance information can be repetitively acquired a plurality of times in a same distance range (sub-frame) and the acquired distance information can be averaged or the like to reduce an effect of noise. Since the number of repetitions of the acquisition of distance information for each distance range constitutes a trade-off between a frame rate and an accuracy of the distance information, the number of repetitions can be appropriately set so as to satisfy practically necessary conditions.

In the present embodiment, the ranging apparatus 100 switches between distance ranges which the light source portion 101 irradiates with light midway through one frame period during which the ranging apparatus 100 generates a distance image based on acquired distance information. The ranging apparatus 100 generates a distance image of a sub-frame based on the distance information obtained for each distance range divided in the depth direction of the ranging object region 99 and generates a distance image of one frame by synthesizing the generated distance images of the sub-frames. In addition, during a process of generating the distance images of the sub-frames, the ranging apparatus 100 modifies an irradiated region of light of the light source portion 101. Accordingly, compared to a configuration in which an image for each distance range is generated without modifying the irradiated region of light in the depth direction of the ranging object region 99, acquisition efficiency of distance information in the depth direction of the ranging object region 99 can be improved while suppressing an increase in power consumption by the light source portion.

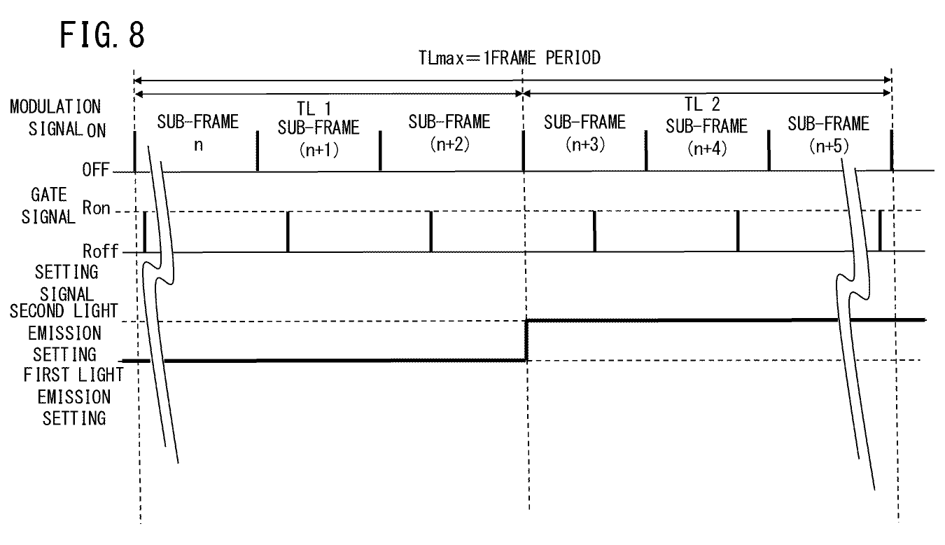

Next, an example of switching between irradiated regions of irradiation light during a sequence of generating a distance image of one frame in the ranging apparatus 100 will be described with reference to FIG. 8 to FIGS. 10A and 10B. In FIG. 8, in order to generate a distance image in a distance range that corresponds to a distance Lmax from the ranging apparatus 100 shown in FIG. 1, distance images of a plurality of sub-frames are generated in one frame period (TLmax). In addition, the ranging apparatus 100 switches between irradiated regions of light emitted by the light source portion 101 at any timing during one frame period. In this case, it is assumed that the irradiated regions of light by the light source portion 101 are to be switched at a timing where the generation of a distance image corresponding to a distance L1 from the ranging apparatus 100 is completed.

As shown in FIG. 8, this example represents a relationship among a modulation signal which controls light emission of the light source portion 101, a gate signal which controls light reception of the light receiving portion 102, and a setting signal of a light emission setting which the setting portion 304 transmits to the light source portion 101. In this case, the first light emission setting is a light emission setting of irradiating a first distance range in the ranging object region with light and the second light emission setting is a light emission setting of irradiating a second distance range in the ranging object region with light. In the graph shown in FIG. 8, an abscissa represents time and an ordinate represents a signal level. As shown in the drawing, in one frame period TLmax, during a period TL1 until a distance image of a sub-frame (n + 2) is generated, the light source portion 101 irradiates the first distance range with light. In addition, during a period TL2 in which distance images of a next sub-frame (n + 3) to a sub-frame (n + 5) are generated, the light source portion 101 irradiates the second distance range with light. Note that the sub-frames n to n + 2 are examples of the first sub-frame and the sub-frames n + 3 to n + 5 are examples of the second sub-frame.

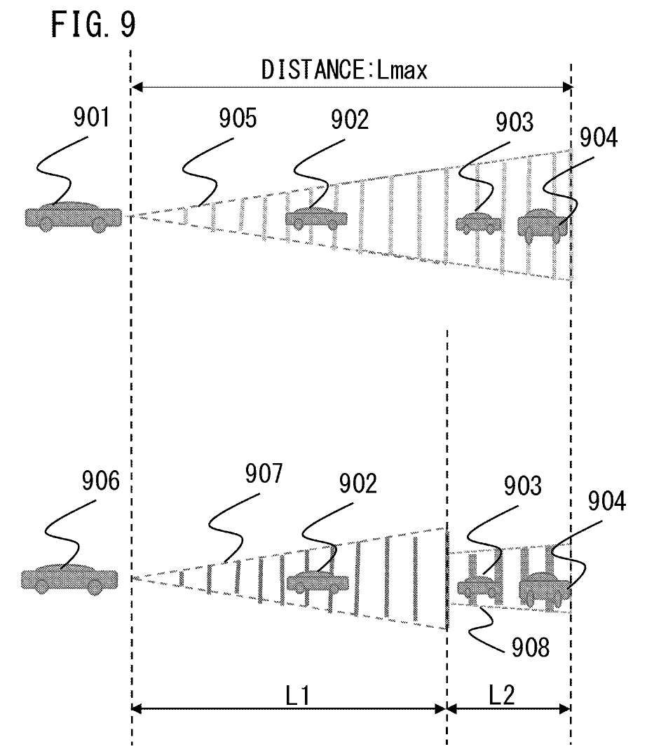

FIG. 9 is a schematic view showing an example of a case where the ranging apparatus 100 in the first embodiment is applied as a vehicle-mounted ranging apparatus. FIG. 9 shows an automobile 901 not mounted with the ranging apparatus 100 and an automobile 906 mounted with the ranging apparatus 100. Here, a case where other automobiles 902, 903, and 904 are traveling ahead of the automobiles 901 and 906 will be conceived.

In the case of the automobile 901, the automobile 901 is traveling while irradiation light for ranging spreads forward up to the distance Lmax. In this case, the farther away from the automobile 901, the wider the irradiation light and the weaker the irradiation light.

On the other hand, with the automobile 906 mounted with the ranging apparatus 100 according to the present embodiment, when generating a distance image in a distance range from the automobile 906 up to the distance L1, the light source portion 101 irradiates light at the first light emission setting. Accordingly, in the ranging apparatus 100, a distance image of the automobile 902 is generated by light emitted from the light source portion 101 at the first light emission setting. In addition, with the automobile 906, when generating a distance image in a distance range corresponding to a remaining distance L2 or, in other words, a distance range from the distance L1 up to the distance Lmax, the light source portion 101 irradiates light at the second light emission setting. Accordingly, in the ranging apparatus 100, a distance image of the automobiles 903 and 904 is generated by light emitted from the light source portion 101 at the second light emission setting.

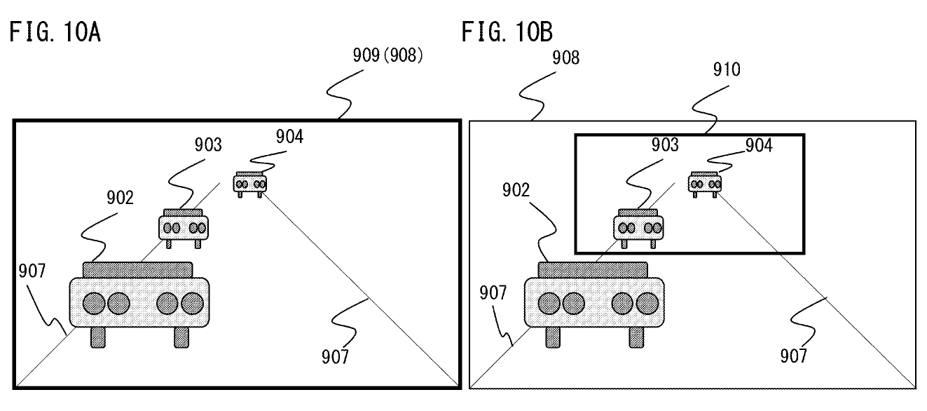

FIGS. 10A and 10B are diagrams schematically showing an imaging region 908 according to the ranging apparatus 100 mounted to the automobile 906 shown in FIG. 9. Note that FIG. 10A shows an irradiation range 909 of light in a case where the light source portion 101 of the ranging apparatus 100 irradiates light at the first light emission setting. In addition, FIG. 10B shows an irradiation range 910 of light in a case where the light source portion 101 of the ranging apparatus 100 irradiates light at the second light emission setting. Furthermore, in the drawings, lanes 907 on a road on which each automobile travels are schematically shown.

Of the ranging object region from the automobile 906 to the distance Lmax, a distance range from the automobile 906 to the distance L1 is a closer distance range as viewed from the automobile 906. Therefore, when viewed from the automobile 906, the automobile 902 within this distance range is larger than the automobiles 903 and 904 in a distance range which is farther than the distance L1. Therefore, as shown in FIG. 10A, the first light emission setting is a light emission setting in which the irradiation range 909 of light emitted from the light source portion 101 encompasses the entire imaging region 908. Note that the irradiation range 909 of light in the imaging region 908 may be a range narrower than the imaging region 908 as long as the irradiation range 909 encompasses automobiles within a distance range from the automobile 906 up to the distance L1.

On the other hand, the distance range from the automobile 906 up to the remaining distance L2 which is farther than the distance L1 in the ranging object region 99 is a farther distance range as viewed from the automobile 906. Therefore, as shown in FIG. 10B, the second light emission setting is a light emission setting in which the irradiation range 910 of light emitted from the light source portion 101 encompasses the automobiles 903 and 904 in the imaging region 908. As described above, in the ranging apparatus 100, when generating a distance image of a region corresponding to a far field in the imaging region 908 in a sequence of generating a distance image of the entire ranging object region, a light emission setting (second light emission setting) which narrows the irradiated region of light by the light source portion 101 is used. In this manner, light emission settings with different light intensities of light emitted from the light source portion 101 are used between the first light emission setting and the second light emission setting. Accordingly, the ranging apparatus 100 can reduce power consumption in proportion to a narrowed amount of the irradiated region and, by increasing the irradiated light amount of the light source portion 101 in accordance with the reduction in power consumption, the ranging apparatus 100 can more efficiently generate a distance image.

In addition, as a modification of the embodiment described above, a wavelength of light emitted by the light source portion 101 may be modified instead of or in addition to modifying the irradiated region of the light and/or the light intensity of light in accordance with a distance range to be irradiated with the light according to the first light emission setting and the second light emission setting. For example, when the light emitted by the light source portion 101 in the embodiment described above is infrared light, the first light emission setting and the second light emission setting are to be light emission settings which modify the wavelength of light emitted by the light source portion 101 to respectively different wavelengths within a range of 950 nm to 1400 nm. Furthermore, as the light receiving portion 102, a sensor using a GaAs-based compound semiconductor or a semiconductor including Ge can be adopted. In this manner, due to the light emission settings including a setting related to the wavelength of light emitted by the light source portion, a distance image with higher accuracy can be expected to be generated by having the ranging apparatus 100 irradiate ranging light with an appropriate wavelength for each distance range to be irradiated with the light.

### Second Embodiment

Next, a ranging apparatus according to a second embodiment will be described. It should be noted that, in the following description, components similar to those of the first embodiment will be denoted by the same reference signs and detailed descriptions thereof will be omitted. In a ranging apparatus 200 according to the second embodiment, a configuration of a light receiving element of the light receiving portion 102 differs from that of the light receiving portion 102 according to the first embodiment.

In the present embodiment, the light receiving element of the light receiving portion 102 is a light receiving element from which a detection signal is output only when an amount of received light exceeds a prescribed light amount during a period where the gate signal is turned ON. The light receiving element only detects whether or not the prescribed light amount is being received and does not detect a gradation of the amount of received light. Therefore, the light receiving element in the light receiving portion 102 according to the present embodiment has a higher detection accuracy than in the first embodiment, a circuit configuration for extracting a detection signal can be made simpler, and a detection signal can be output at a higher rate. As the light receiving element, an avalanche photodiode such as a SPAD (Single Photon Avalanche Diode) detector can be used. In the present embodiment, by generating a distance image of each distance range by combining a highly-sensitive light receiving element and control of a gate signal, the ranging apparatus 200 with a simpler configuration can be realized.

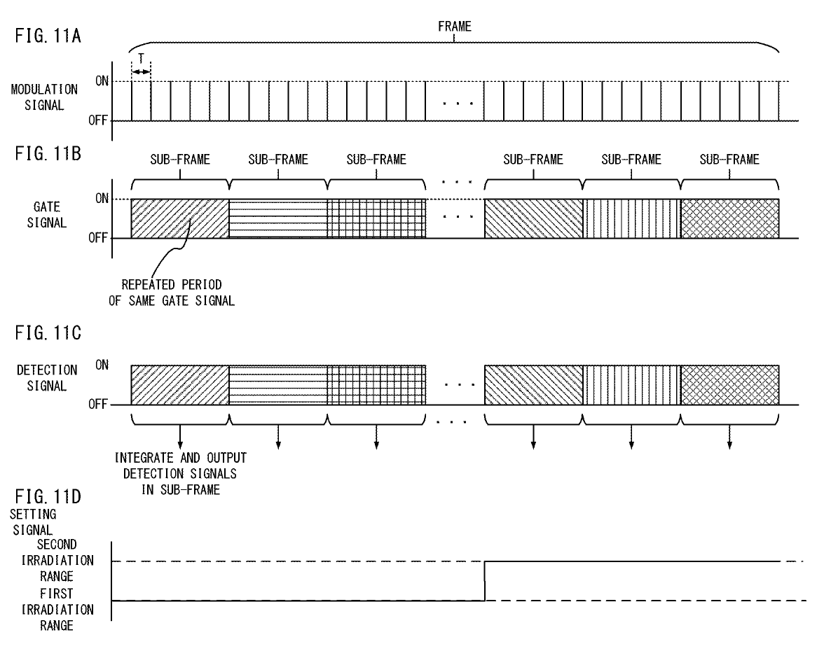

A modification of the present embodiment will now be described with reference to FIGS. 11A to 11D. FIG. 11A shows a modulation signal for controlling light emission of the light source portion 101 and FIG. 11B shows a gate signal for controlling light reception of the light receiving portion 102. FIG. 11C shows a detection signal transmitted from the light receiving portion 102 to the frame image generating portion 305 and FIG. 11D shows a setting signal of a light emission setting which is transmitted to the light source portion 101 by the setting portion 304. In the graphs shown in FIGS. 11A to 11D, an abscissa represents time and an ordinate represents a signal level.

In the modification described below, when generating a distance image for each distance range (sub-frame) created by dividing a ranging object region, the light source portion 101 emits light a plurality of times (N-number of times, where N is any integer) in one sub-frame. In a similar manner, in the sub-frame, the light receiving portion 102 integrates detection signals from the receiving element N-number of times and obtains a detection signal corresponding to one sub-frame. Since the light receiving element such as a SPAD detector which constitutes the light receiving portion 102 according to the present embodiment only detects whether or not a prescribed light amount is being received, processing load of generating a distance image can be reduced and high sensitivity with respect to the amount of received light can be realized.

In the light receiving portion 102 according to the present embodiment, information such as a gradation of the amount of received light is not acquired. However, since the reflected light 202 from a recognition object in the ranging object region is diffusely reflected by a surface of the object, the light that reaches the light receiving element of the light receiving portion 102 is a part of the diffusely reflected light. Therefore, detection of the reflected light 202 by the light receiving portion 102 may possibly be probabilistic. As a result, even if the ranging object region is divided into a plurality of distance ranges at same distances, there is no guarantee that the reflected light from the recognition object can be detected by the light receiving element in each distance range. In addition, by repeating light emission by the light source portion 101 and light reception by the light receiving portion 102, a detection probability of reflected light from the recognition object in the light receiving portion 102 can be comprehended.

Accordingly, in the present modification, information related to a gradation of the amount of received light for each distance range (sub-frame) is acquired by integrating the number of detections of reflected light due to repetitively performing light emission by the light source portion 101 and light reception by the light receiving portion 102 and outputting the number of detections obtained by the integration as a detection signal. Therefore, with the ranging apparatus 200 according to the present embodiment, a distance image can be generated by acquiring information that even includes information of a gradation of an amount of received light with a simpler apparatus configuration.

### Third Embodiment

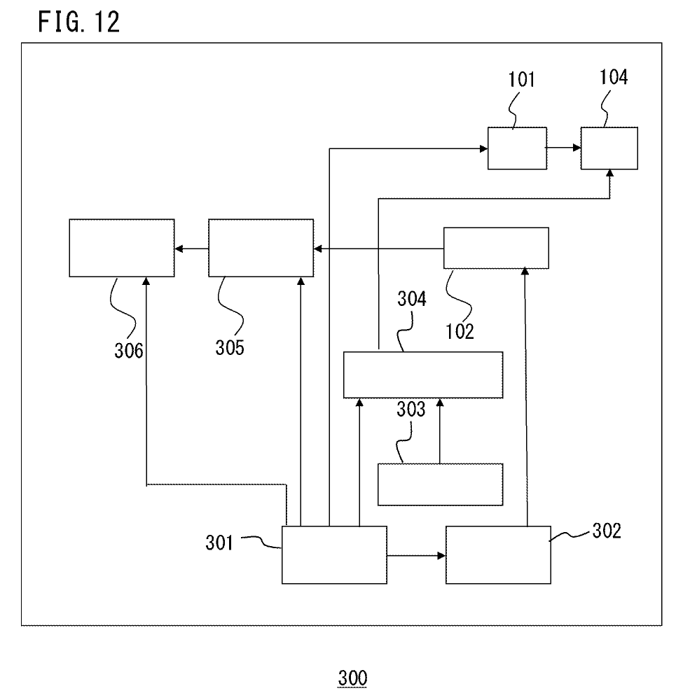

Next, a ranging apparatus according to a third embodiment will be described. It should be noted that, in the following description, components similar to those of the embodiments described above will be denoted by the same reference signs and detailed descriptions thereof will be omitted. FIG. 12 shows a schematic configuration of a ranging apparatus 300 according to the third embodiment. As shown in FIG. 12, the ranging apparatus 300 according to the present embodiment includes, in a stage subsequent to the light source portion 101, an irradiated region modifying portion 104 which modifies an irradiated region of light emitted by the light source portion 101. In addition, the timing control portion 301 respectively transmits control signals to the frame image generating portion 305 and the image synthesizing portion 306. Furthermore, the setting portion 304 controls an operation of the irradiated region modifying portion 104 based on the control signal transmitted from the timing control portion 301.

The irradiated region modifying portion 104 is constituted of a member which deflects laser light such as a liquid crystal member, an electro-optical deflection element, or an acousto-optical deflection element and controls irradiation of light emitted by the light source portion 101 in accordance with the control signal transmitted from the setting portion 304. Alternatively, the irradiated region modifying portion 104 may be constituted of a mechanical member such as a MEMS (Micro Electro Mechanical Systems) device or a galvano mirror. Accordingly, the irradiated region modifying portion 104 controls the irradiation of light emitted by the light source portion 101 by modifying at least one of an irradiation angle and an irradiation range of laser light.

In addition, the timing control portion 301 respectively transmits control signals to the frame image generating portion 305 and the image synthesizing portion 306 and controls generation processing of a distance image. Specifically, the timing control portion 301 modifies processing of generation of sub-frame images and synthesis of sub-frame images in accordance with a modification in an irradiated light amount by the light source portion 101 during a period of one frame. For example, in the period of one frame, the number of sub-frame images to be synthesized is reduced during a period where the light source portion 101 irradiates a distance range which is closer to the ranging apparatus 300 in the ranging object region according to the first light emission setting. On the other hand, in the period of one frame, the number of sub-frame images to be synthesized is increased during a period where the light source portion 101 irradiates a distance range which is farther from the ranging apparatus 300 in the ranging object region according to the second light emission setting.

The timing control portion 301 switches between types of synthesis processing of sub-frame images in this manner by controlling the frame image generating portion 305 and the image synthesizing portion 306. As a result, according to the ranging apparatus 300, a decline in image quality of a distance image attributable to a reduction in an irradiated light amount when the distance range that is an irradiation object of light moves farther away. Note that, in the ranging apparatus 300, processing such as interpolation may be executed with respect to distance images which are synthesized before and after the light emission setting of the light source portion 101 is switched from the first light emission setting to the second light emission setting.

Therefore, with the ranging apparatus 300 according to the present embodiment, during a period of generating distance images corresponding to one frame, a difference in amounts of light with which ranging objects are irradiated between a vicinity of the ranging apparatus 300 and faraway from the ranging apparatus 300 can be reduced. As a result, efficient distance images with high image quality can be generated without increasing power consumption of the ranging apparatus 300.

### Fourth Embodiment

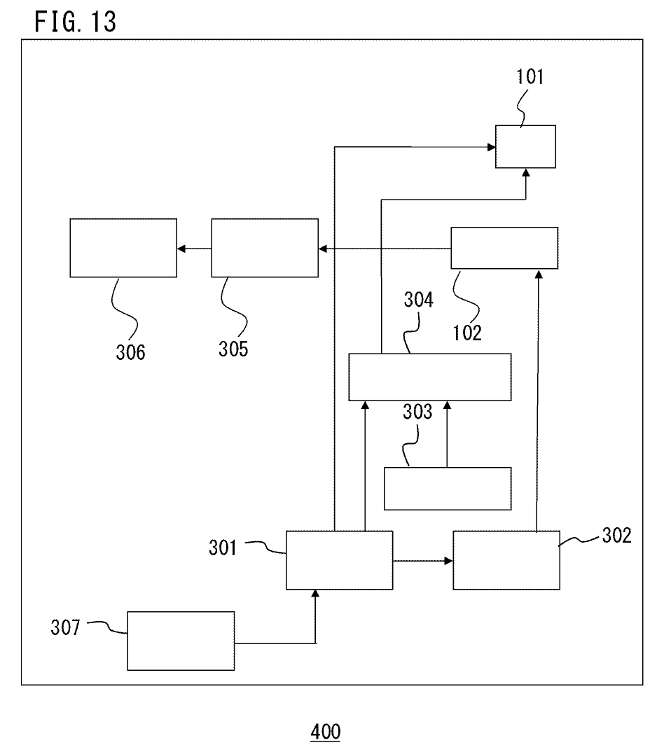

Next, a ranging apparatus according to a fourth embodiment will be described. It should be noted that, in the following description, components similar to those of the embodiments described above will be denoted by the same reference signs and detailed descriptions thereof will be omitted. FIG. 13 shows a schematic configuration of a ranging apparatus 400 according to the fourth embodiment. As shown in FIG. 13, the ranging apparatus 400 includes an external environment information acquiring portion 307 which acquires information related to an external environment of the ranging apparatus 400. For example, the external environment information acquiring portion 307 acquires information such as a difference between day and night in a use environment of the ranging apparatus 400 or a difference in weather such as sunny, rainy, or foggy. On the basis of the information acquired by the external environment information acquiring portion 307, the timing control portion 301 switches between light emission settings of the light source portion 101 via the setting portion 304 in accordance with the difference in external environment.

As a specific example, when using the ranging apparatus 400 during the daytime on a sunny day, many pieces of information can be obtained from an image taken by a visible-light camera under strong external light. In consideration thereof, when the information acquired by the external environment information acquiring portion 307 indicates daytime on a sunny day, the timing control portion 301 switches the light emission setting of the light source portion 101 from the first light emission setting to the second light emission setting in a generation stage of a sub-frame image of a distance range which is closer to the ranging apparatus 400. Accordingly, by shortening a period during which the light source portion 101 emits light at the first light emission setting, power consumption that accompanies the light emission by the light source portion 101 can be reduced.

On the other hand, when using the ranging apparatus 400 at night, visibility in an image taken by a visible-light camera is poor. In consideration thereof, when the information acquired by the external environment information acquiring portion 307 indicates nighttime, the timing control portion 301 switches the light emission setting of the light source portion 101 from the first light emission setting to the second light emission setting in a generation stage of a sub-frame image of a distance range which is farther from the ranging apparatus 400. Accordingly, in a similar manner to the first embodiment, the ranging apparatus 400 can reduce power consumption in proportion to a narrowed amount of the irradiated region and, by increasing the irradiated light amount of the light source portion 101 in accordance with the reduction in power consumption, the ranging apparatus 400 can generate a more accurate distance image.

As another example, the timing control portion 301 switches between light emission settings of the light source portion 101 when the information acquired by the external environment information acquiring portion 307 indicates bad weather such as rain or fog. Specifically, the timing control portion 301 switches the light emission setting of the light source portion 101 from the first light emission setting to the second light emission setting in a generation stage of a sub-frame image of a distance range which is closer to the ranging apparatus 400 than in a case where the ranging apparatus 400 is used in fine weather. Accordingly, by switching the light emission setting of the light source portion 101 to the second light emission setting, the ranging apparatus 400 can reduce power consumption in proportion to a narrowed amount of the irradiated region and can increase the irradiated light amount of the light source portion 101 in accordance with the reduction in power consumption. As a result, even in bad weather, the ranging apparatus 400 can generate distance images with higher accuracy.

Therefore, with the ranging apparatus 400 according to the present embodiment, a timing at which irradiated regions of light of the light source portion 101 in the sequence of generating distance images of one frame is modified in accordance with the acquired information indicating external environment. Accordingly, the ranging apparatus 400 can generate a suitable distance image in accordance with the weather or a daily variation in external light.

### Fifth Embodiment

Next, a ranging apparatus according to a fifth embodiment will be described. It should be noted that, in the following description, components similar to those of the embodiments described above will be denoted by the same reference signs and detailed descriptions thereof will be omitted.

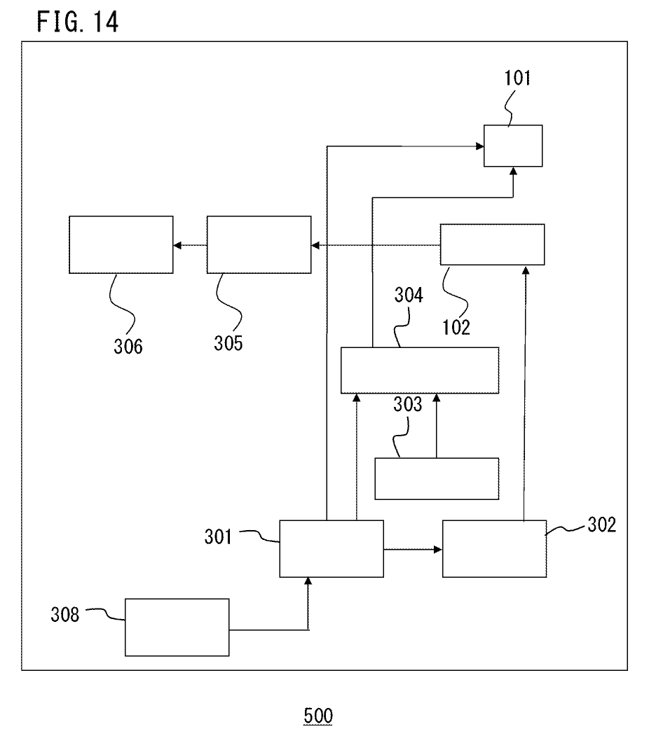

FIG. 14 shows a schematic configuration of a ranging apparatus 500 according to the fifth embodiment. As shown in FIG. 14, the ranging apparatus 500 includes a movement information acquiring portion 308 which acquires information related to a movement of the ranging apparatus 500. As an example, when the ranging apparatus 500 is mounted to an automobile which is a moving body, the movement information acquiring portion 308 acquires travel information indicating whether the automobile is presently traveling on a highway or traveling a general road as movement information. On the basis of the movement information acquired by the movement information acquiring portion 308, the timing control portion 301 switches between light emission settings of the light source portion 101 via the setting portion 304 in accordance with the difference in movement situations of the ranging apparatus 500.

As a specific example, when the automobile mounted with the ranging apparatus 500 is traveling on a highway, light emission control of further narrowing an irradiation range of light or the like is performed when the light source portion 101 emits light according to the second light emission setting. Accordingly, in the ranging apparatus 500, a distance image with higher accuracy can be generated by increasing an irradiated light amount by the light source portion 101 while narrowing an irradiation range of light by the light source portion 101 than the irradiation range of light in a case where the automobile is traveling on a general road to reduce power consumption.

In addition, as another example, the movement information acquiring portion 308 can acquire information such as a frequency of braking of an automobile mounted with the ranging apparatus 500 and the timing control portion 301 can determine whether or not the automobile is traveling on a congested road based on the acquired information. In this case, when the timing control portion 301 determines that the automobile is presently traveling on a congested road, the timing control portion 301 performs control of narrowing an irradiation range of light by the light source portion 101 than the irradiation range of light in a case where the automobile is traveling on a general road to increase an irradiated light amount. Furthermore, the timing control portion 301 may limit a distance range in which sub-frame images are to be generated to a distance range in a vicinity of the ranging apparatus 500 and exclude distance ranges far from the ranging apparatus 500. Accordingly, in the ranging apparatus 500, by reducing the number of sub-frame images to be synthesized, one frame period in which distance images are to be synthesized can be reduced. As a result, according to the ranging apparatus 500, a determination time of an inter-vehicle distance during a congestion can be reduced when an automobile mounted with the ranging apparatus 500 travels on a congested road.

Therefore, according to the present embodiment, a timing at which irradiated ranges of light of the light source portion 101 are switched, an irradiation range, an irradiated light amount, or the like in the sequence of generating distance images of one frame can be controlled using travel information of an automobile mounted with the ranging apparatus 500 or the like. Accordingly, the ranging apparatus 500 can generate a suitable distance image in accordance with a situation of use of the ranging apparatus 500.

### Sixth Embodiment

Next, a ranging apparatus according to a sixth embodiment will be described. It should be noted that, in the following description, components similar to those of the embodiments described above will be denoted by the same reference signs and detailed descriptions thereof will be omitted.

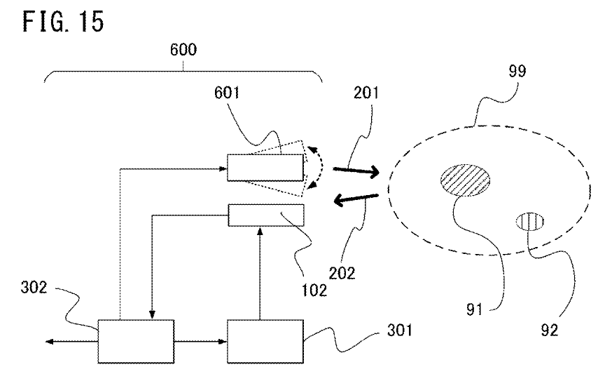

FIG. 15 is a diagram schematically showing a part of a configuration of a ranging apparatus 600 according to the sixth embodiment and emission and reception of light by the ranging apparatus 600. Constituent elements included in the ranging apparatus 600 but not shown in FIG. 15 are similar to those of the ranging apparatus 100 according to the first embodiment. As shown in FIG. 15, the ranging apparatus 600 according to the present embodiment generates a distance image of each distance range by modifying an irradiation angle of light of the light source portion 101 with respect to the ranging object region 99 by a minute angle every time the light source portion 101 emits light.

When a part of a recognition object is constituted by a glossy surface or a surface with a special shape, depending on an angle of incidence of light to the recognition object, there is a possibility of occurrence of an unmanageable state where a light amount of the reflected light reaching the light receiving portion 102 increases unnaturally. The ranging apparatus 600 according to the present embodiment generates a distance image while modifying an irradiation angle of light of the light source portion 101 with the timing control portion 301. Accordingly, the light source portion 101 modifies the irradiation direction of light every time the light source portion 101 emits light. As a result, with the ranging apparatus 600, a phenomenon in which an inaccurate distance image is generated due to an abnormal amount of received reflected light in the light receiving portion 102 which is attributable to a shape or a surface configuration of the recognition object can be reduced.

As a specific example, the timing control portion 301 modifies the irradiation angle of light of the light source portion 101 by small increments every time the light source portion 101 emits light in the sequence of generating one sub-frame image and repetitively performs light reception of reflected light by the light receiving portion 102. In addition, by averaging information obtained from the reflected light having been received by the light receiving portion 102, the frame image generating portion 305 can generate a sub-frame image by reducing noise attributable to characteristics of a surface of a recognition object.

While a configuration in which the light source portion 101 moves so as to modify the irradiation direction of light has been described in the present embodiment, a configuration in which the light receiving portion 102 moves in place of the light source portion 101 or in addition to the light source portion 101 may also be adopted. In this case, the light receiving portion 102 modifies a light reception angle of reflected light every time the light source portion emits light. Even when adopting such a configuration, the ranging apparatus 600 can generate a sub-frame image by reducing noise attributable to characteristics of the surface of the recognition object in a similar manner to that described above.

### Seventh Embodiment

Next, a ranging apparatus according to a seventh embodiment will be described. It should be noted that, in the following description, components similar to those of the embodiments described above will be denoted by the same reference signs and detailed descriptions thereof will be omitted. A configuration of a ranging apparatus 700 according to the seventh embodiment is the same as that of the ranging apparatus 100 according to the first embodiment. However, as will be described below, a modulation timing of the light source portion 101 differs from the light source portion 101 according to the first embodiment.

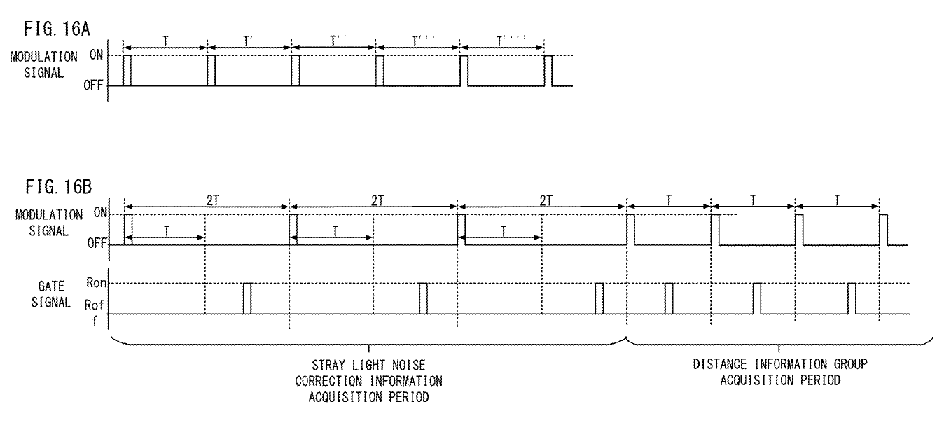

FIG. 16A shows an example of a modulation signal which is a control signal of a modulation timing of the light source portion 101 in the ranging apparatus 700 according to the present embodiment. In FIG. 16A, an abscissa represents time and an ordinate represents a signal level. In the graph shown in FIG. 16A, an abscissa represents time and an ordinate represents a signal level. As shown in the drawing, in the ranging apparatus 700, the timing control portion 301 varies periods at which the light source portion 101 is modulated for each light emission timing to respectively different periods of T, T’, T’’, T’’’, and T’’’’. In this manner, the light source portion 101 modifies a light emission period of light every time the light source portion 101 emits light.

When the light source portion 101 repetitively modulates at light emission timings of a same period (for example, the period T), the period T is often set as short as possible in order to maximize a frame rate. Therefore, when a phenomenon occurs in which light irradiated from a region farther than a ranging object region is reflected, there is a possibility that the reflected light may overlap with reflected light from a recognition object in a distance range which is an irradiation object of light and may create noise. Specifically, light reflected by a region farther than the ranging object region by a first light emission of the light source portion 101 becomes stray light noise of light reflected by a recognition object in a distance range which is an irradiation object of light by a second light emission of the light source portion 101. As a result, accuracy of a generated sub-frame image may possibly decline.

In the present embodiment, since a period at which the light source portion 101 is modulated varies for each light emission timing, a timing of a next light emission of the light source portion 101 can be made different from a timing where unnecessary reflected light becomes stray light. Accordingly, reflected light from the recognition object having been irradiated at different light emission timings in one distance range is repeatedly acquired by the light receiving portion 102. In addition, by averaging information obtained from the reflected light having been received by the light receiving portion 102, the frame image generating portion 305 can generate a sub-frame image by reducing noise attributable to stray light.

FIG. 16B shows an example of a modulation signal which controls a light emission timing of the light source portion 101 and a gate signal which controls a light reception timing of the light receiving portion 102 as a modification of the present embodiment. In FIG. 16B, an abscissa represents time and an ordinate represents a signal level. As shown in FIG. 16B, in the ranging apparatus 700 according to the present modification, the timing control portion 301 controls operations of the light source portion 101 and the light receiving portion 102 so as to provide a period of acquiring correction information of stray light noise before a generation period of a distance image (“distance information group acquisition period” in the drawing).

As shown in the drawing, in a period of acquiring information for correcting stray light noise (“stray light noise correction information acquisition period” in the drawing), a period during which the modulation signal is turned ON is a period 2T that is twice as long as a period T used when generating a distance image. Furthermore, as shown in the drawing, in the period of acquiring information for correcting stray light noise, a timing at which the gate signal is turned ON is set during an interval between the modulation signal being turned ON and the modulation signal being next turned ON after a passage of a time T or more.

In this manner, due to the timing control portion 301 controlling a modulation signal for controlling a light emission timing of the light source portion 101 and a gate signal for controlling a light reception timing of the light receiving portion 102, the ranging apparatus 700 can acquire information for correcting stray light noise before the generation of a distance image. Accordingly, the ranging apparatus 700 can generate a distance image by eliminating stray light noise based on the acquired information.

### Eighth Embodiment

Next, a ranging apparatus according to an eighth embodiment will be described. It should be noted that, in the following description, components similar to those of the embodiments described above will be denoted by the same reference signs and detailed descriptions thereof will be omitted. A configuration of a ranging apparatus 800 according to the eighth embodiment is the same as that of the ranging apparatus 100 according to the first embodiment. However, as will be described below, control of the light receiving portion 102 differs from the first embodiment.

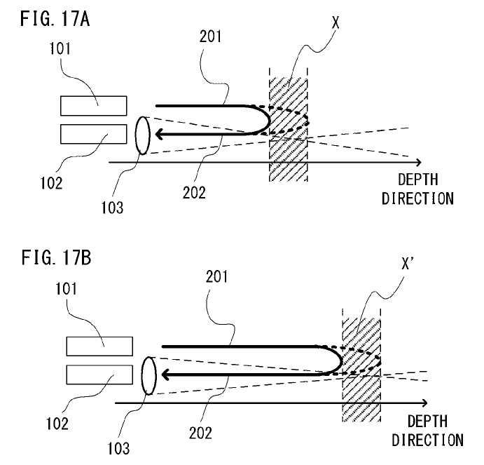

The ranging apparatus 800 according to the present embodiment will be described with reference to FIGS. 17A and 17B. FIGS. 17A and 17B are diagrams schematically showing light emission by the light source portion 101 and light reception by the light receiving portion 102 in the ranging apparatus 800. In the ranging apparatus 800, the light receiving portion 102 is provided with a lens 103 of which an Fno (F value; F number) is small and a depth of focus is relatively narrow as an optical member for shaping light with respect to a recognition object. The light receiving portion 102 is configured to be capable of modifying a focal length of the lens 103. In addition, based on control by the gate signal generating portion 302, the light receiving portion 102 varies the focal length of the lens 103 so as to overlap with a distance range (distance range X and distance range X’ in the drawing) to be an irradiation object of light. Accordingly, due to the light receiving portion 102 receiving reflected light from a recognition object in the distance range in a more optically efficient manner, the ranging apparatus 800 can generate a more accurate distance image.

### Ninth Embodiment

Next, a ranging apparatus according to a ninth embodiment will be described. It should be noted that, in the following description, components similar to those of the embodiments described above will be denoted by the same reference signs and detailed descriptions thereof will be omitted. A configuration of a ranging apparatus 900 according to the ninth embodiment is the same as that of the ranging apparatus 100 according to the first embodiment. The ranging apparatus 900 is provided with a mechanism for controlling a gate signal for every plurality of light receiving elements which constitute the light receiving portion 102.

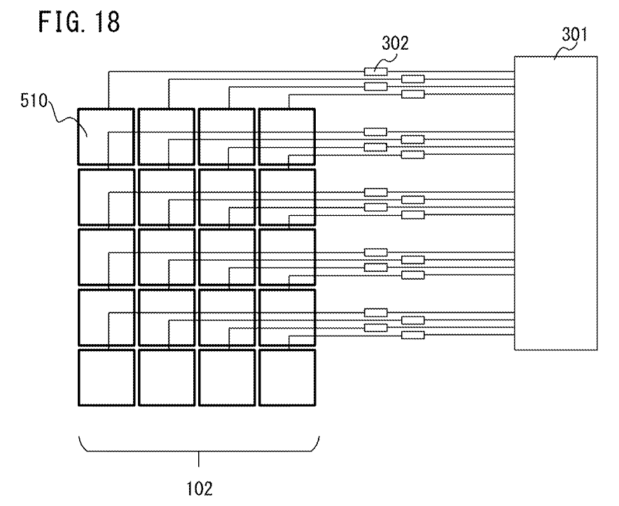

FIG. 18 schematically shows configurations of light receiving elements 510 included in the light receiving portion 102, the timing control portion 301, and the gate signal generating portion 302 of the ranging apparatus 900 according to the present embodiment. As shown in the drawing, the light receiving portion 102 of the ranging apparatus 900 includes a plurality of light receiving elements 510 and each light receiving element 510 is connected to each gate signal generating portion 302. Accordingly, by controlling each gate signal generating portion 302, the timing control portion 301 can set a value of the time width TW of the gate signal for each light receiving element 510. Note that, when necessary, the timing control portion 301 may set the value of the delay time TD of the gate signal for each light receiving element 510.

In the ranging apparatus 900, by controlling a timing at which the gate signal is turned ON for each light receiving element 510, a distance range to be a light receiving object of reflected light can be set for each light receiving element 510. Accordingly, the time width and/or a delay time of the gate signal can be modified for each light receiving element 510 and the distance range in the depth direction of the ranging object region can be modified for each light receiving element 510. As a result, when viewed in the depth direction of the ranging object region, the ranging apparatus 900 can not only generate a planar distance image but can also generate a distance image that is a curved surface. Note that a curvature of the curved surface of the generated distance image can be appropriately modified by modifying control of each light receiving element 510 by the timing control portion 301 according to the use environment of the ranging apparatus 900.

Therefore, with the ranging apparatus 900 according to the present embodiment, by controlling the gate signal to be transmitted to each light receiving element 510 which constitutes the light receiving portion 102, a distance range to be a light receiving object of the light receiving element 510 can be optimized in greater detail. As a result, the ranging apparatus 900 can generate a distance image containing more useful information related to a recognition object.

With the techniques according to the present disclosure, accuracy of distance information of a ranging object can be improved while suppressing an increase in power consumption of a light source in a ranging apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-085401, filed on May 24, 2023, which is hereby incorporated by reference herein in its entirety.

What is claimed is:

1. A ranging apparatus, comprising:
a light source portion which emits light;
a setting portion which performs light emission setting of the light source portion;
a light receiving portion which receives reflected light of the light having been emitted from the light source portion and reflected by an object; and
a generating portion which generates a distance image using the reflected light having been received by the light receiving portion, wherein
the distance image is made up of a plurality of sub-frames of distance images,
in a process of generating the plurality of sub-frames, the setting portion performs first light emission setting when performing ranging of a first distance range and performs second light emission setting when performing ranging of a second distance range, and
the first light emission setting and the second light emission setting include setting of an irradiated region of the light emitted by the light source portion.

2. The ranging apparatus according to claim 1, wherein the first light emission setting and the second light emission setting include setting related to light intensity of the light emitted by the light source portion.

3. The ranging apparatus according to claim 1, wherein the first light emission setting and the second light emission setting include setting related to a wavelength of the light emitted by the light source portion.

4. The ranging apparatus according to claim 1, wherein
the setting portion switches between the first light emission setting and the second light emission setting so that
the generating portion generates a distance image of a first sub-frame among the plurality of sub-frames using the reflected light of the light having been emitted from the light source portion according to the first light emission setting and
the generating portion generates a distance image of a second sub-frame among the plurality of sub-frames using the reflected light of the light having been emitted from the light source portion according to the second light emission setting.

5. The ranging apparatus according to claim 1, wherein
the light receiving portion includes a light receiving element which detects that an amount of received light has exceeded a prescribed light amount, and
the generating portion generates the distance image using a detection result of the light receiving element.

6. The ranging apparatus according to claim 5, wherein the light receiving element repetitively performs light reception of the reflected light at constant time intervals when performing ranging of at least one of the first distance range and the second distance range.

7. The ranging apparatus according to claim 1, further comprising:
an environmental information acquiring portion which acquires environmental information related to an external environment of the ranging apparatus, wherein
the setting portion switches between the first light emission setting and the second light emission setting based on the environmental information acquired by the environmental information acquiring portion.

8. The ranging apparatus according to claim 1, further comprising:
a movement information acquiring portion which acquires movement information related to a movement of the ranging apparatus, wherein
the setting portion switches between the first light emission setting and the second light emission setting based on the movement information acquired by the movement information acquiring portion.

9. The ranging apparatus according to claim 1, wherein the light source portion switches among distance ranges to be irradiated with the light using at least one of polarization and modulation.

10. The ranging apparatus according to claim 9, wherein the light source portion switches among distance ranges to be irradiated with the light using at least any of a silicon photonics device, a compound semiconductor, and an optical phased array.

11. The ranging apparatus according to claim 1, wherein the light source portion switches among distance ranges to be irradiated with the light by modifying a light emission area of the light source portion.

12. The ranging apparatus according to claim 11, wherein the light source portion switches among distance ranges to be irradiated with the light using a surface-emitting laser made up of a plurality of laser point groups.

13. The ranging apparatus according to claim 1, further comprising at least any of a liquid crystal member, an electro-optical deflection element, and an acousto-optical deflection element which deflects the light emitted by the light source portion.

14. The ranging apparatus according to claim 1, further comprising at least any of a MEMS (Micro Electro Mechanical Systems) device and a galvano mirror which modifies at least one of an irradiation angle and an irradiation range of the light due to the light source portion.

15. The ranging apparatus according to claim 1, wherein the light source portion modifies an irradiation direction of the light every time the light source portion emits the light.

16. The ranging apparatus according to claim 1, wherein the light receiving portion modifies a light reception angle of the reflected light every time the light source portion emits the light.

17. The ranging apparatus according to claim 1, wherein the light source portion modifies a light emission period of the light every time the light source portion emits the light.

18. The ranging apparatus according to claim 1, wherein
the light receiving portion includes an optical member of which a focal length can be modified, and
the light receiving portion modifies the focal length of the optical member in accordance with a distance range to be irradiated with the light.

19. The ranging apparatus according to claim 1, wherein
the light receiving portion includes a plurality of light receiving elements which receive the reflected light, and
each light receiving element of the plurality of light receiving elements receive the reflected light in a different distance range.
